(19) United States
(12) Patent Application Publication
(10) Pub. No.: US 2004/0043762 A1
(43) Pub. Date: Mar. 4, 2004

(54) System and method for processing information and data in mobile telephone

(76) Inventors: Jae-Min Kim, Kumi-shi (KR); Moon-Heul Lee, Kumi-shi (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/641,120

(22) Filed: Aug. 15, 2003

(30) Foreign Application Priority Data
Sep. 4, 2002 (KR) 2002-53060

(51) Int. Cl. H04M 3/00

(52) U.S. Cl. 455/418; 455/412.1

(57) ABSTRACT

A system and method for processing information and data in a mobile telephone is disclosed. The system and method employ the operations of confirming whether received information and data have a registered pattern, sorting the received information and data containing the registered pattern by pattern types; processing the information and data according to a sorting system when the pattern of the received information and data is at least one of a telephone number stored in a phonebook of said mobile telephone and a specific character string registered to sort the information and data by of one themes, categories, characteristics and kinds, processing the information and data according to a processing system when the pattern of the received information and data is a character string registered for specific display or includes a URL character string; and processing the information and data according to an automatic processing system when the pattern of the received information and data is a specific character string, telephone number or e-mail address registered by the user for rejection of reception.

### PRIORITY

This application claims priority under 35 U.S.C. §119 to an application entitled “METHOD FOR PROCESSING INFORMATION AND DATA IN MOBILE TELEPHONE” filed in the Korean Industrial Property Office on Sep. 4, 2002 and assigned Serial No. 2002-53060, the contents of which are incorporated herein by reference.

### BACKGROUND OF THE INVENTION

1. Field of the Invention

The present invention relates to a system and method for processing information and data in a mobile telephone, and more particularly to a system and method for processing and sorting information received through a mobile telephone. The system and method further relates to a system and method for sorting information addressed to a mobile telephone based on content contained within the received information.

2. Description of the Related Art

Due to the popularity and general acceptance of mobile telephones, mobile telephones have become more than just devices to place and receive voice calls. Mobile telephone users now use their mobile telephones to send and receive a variety of information, e.g., data. Mobile telephone users now have difficulty in managing the large volume of information received through their mobile telephones, which can include unwanted commercial advertisements, email, short messages, and/or junk mail. Since a user pays for airtime to access unsolicited email, reading the unsolicited email can prove costly as both a waste of the users time and money.

### SUMMARY OF THE INVENTION

Therefore, it is an object of the present invention to provide a system and method for selectively sorting information based on patterns in processed information and data received at a mobile telephone.

An object of the present invention can be substantially accomplished by a system and method for processing received information and data at a mobile telephone. The system and method employ the operations of: confirming whether received information and data have a registered pattern; sorting the received information and data containing the registered pattern by pattern types; processing the received information and data according to a sorting system if the pattern of the received information and data is at least one of a telephone number stored in a phonebook of the mobile telephone and a specific character string having been registered to sort the information and data by at least one of characteristics, categories, themes and kinds; storing the received information and data having a telephone number stored in the phonebook as a pattern in the text box of the group in which the telephone number is stored; and storing the information and data having the specific character string which has been registered to sort the information and data by themes or kinds as a pattern in the text box corresponding to the specific character string.

Another object of the present invention, can be substantially accomplished by a system and method for processing information and data in a mobile telephone that comprises the operations of confirming whether received information and data contain a registered pattern; sorting the received information and data containing the registered pattern by pattern types; processing the received information and data according to a processing system if the pattern of the received information and data is a specific character string registered for specific display and includes a URL character string; displaying the received information and data containing that character string as a pattern on a display unit so that the character string can be specifically displayed; and automatically accessing a web browser of the URL when the URL character string is selected from the information and data including the URL character string.

Another object of the present invention can be substantially accomplished, by a system and method for processing information and data in a mobile telephone that comprises the operations of: confirming whether received information and data contain a registered pattern; sorting the received information and data containing the registered pattern by pattern types; processing the received information and data according to an automatic processing system if the pattern of the received information and data is at least one of a specific character string, telephone number and e-mail address registered by the user in order to reject its reception at said mobile telephone; and deleting the received information and data or storing them in a specific box.

Yet another object of the present invention can be substantially accomplished by a system and method for processing information and data in a mobile telephone that includes the operations of: confirming whether received information and data contain a registered pattern; sorting the received information and data containing the registered pattern by pattern types; processing the received information and data according to a sorting system if the pattern of the received information and data is at least one of a telephone number stored in a phonebook and a specific character string having been registered to sort the information and data by categories, characteristics themes and kinds; processing the information and data according to a processing system when the pattern of the received information and data is a character string registered for specific display or includes a URL character string; and processing the information and data according to an automatic processing system when the pattern of the received information and data is a specific character string, telephone number or e-mail address registered by the user in order to reject its reception.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an example of components of a mobile telephone in accordance with a embodiment of the present invention; and

FIG. 2 is a flowchart showing an example of steps performed for processing information and data in a mobile telephone in accordance with the embodiment of the present invention.

### DETAILED DESCRIPTION OF THE PREFERRED EMBODIMENTS

Hereinafter, a system and method for processing information and data in a mobile telephone according to several embodiments of the present invention will be described with reference to the accompanying drawings. Also, a detailed description of known functions and configurations have been omitted for conciseness.

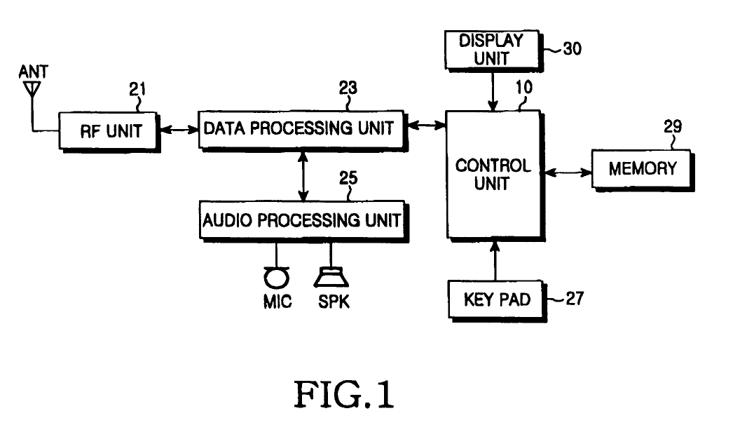

FIG. 1 is a block diagram illustrating an example of components of a mobile telephone in accordance with the present invention. Specifically, the mobile telephone of FIG. 1 comprises a control unit 10, a radio frequency (RF) unit 21, a data processing unit 23, an audio processing unit 25, a key pad 27, a memory 29, a display unit 30, a speaker SP, a microphone MIC, and an antenna ANT. The RF unit 21 performs communication functions for the mobile telephone. The RF unit 21 includes an RF transmitter (not shown) for increasing and amplifying a frequency of a transmitted signal, and an RF receiver (not shown) for low-noise amplifying and decreasing a frequency of a received signal. The data processing unit 23 includes a transmitter (not shown) for encoding and modulating the transmitted signal, and a receiver (not shown) for demodulating and decoding the received signal. That is, the data processing unit 23 can be composed of a modem and a coder/decoder (codec). In one embodiment of the invention the audio processing unit 25 processes an audio signal received from the data processing unit 23. In another embodiment of the invention, the audio processing unit 25 provides the audio signal received from the MIC to the data processing unit 23. The keypad 27 includes keys for inputting number and character information and function keys for setting up various functions.

The memory 29 can be composed of a program memory (not shown) and a data memory (not shown). The program memory has programs for controlling the general operation of the mobile telephone. The data memory temporarily stores data generated while the programs are executed. In accordance with an embodiment of the present invention, the memory 29 can store telephone numbers in a phonebook of the mobile terminal and specific character strings and operate as a sorting system to sort the information and data by themes or categories. In another embodiment of the invention, the memory 29 can store character strings for specific display and universal resource locator (URL) character strings to embody a processing system. The memory 29 can further store user specific telephone numbers, character strings and e-mails to embody an automatic processing system. The mobile terminal user inputs the user specific telephone numbers, character strings and e-mail addresses in order to reject the reception of the inputted information by the mobile telephone. In accordance with an embodiment of the present invention, text boxes for telephone numbers can be arranged by groups to store the information and data containing telephone numbers that are processed according to the sorting system as patterns. In addition, text boxes can be arranged by themes, characteristics, class or categories to store the information and data having the specific character strings that are processed according to the sorting system as patterns. A specific box can be created to store the information and data having the user specific telephone numbers, character strings and e-mail addresses processed according to the automatic processing system as patterns.

A control unit 10 controls the operation of the mobile telephone, and may include the data processing unit 23. In accordance with an embodiment of the present invention, when the information and data are received through the mobile telephone, the control unit 10 confirms whether the received information and data contain a pattern that is stored in the memory 29. If the received information and data contain the pattern stored in the memory 29, the pattern is sorted and transmitted to the sorting system, the processing system or the automatic processing system. The control unit 10 stores the information and data processed according to the sorting system in a corresponding text box. In an embodiment of the invention, the control unit 10 also displays the information and data processed according to the processing system on the display unit 30 with the registered character string specifically displayed. In another embodiment of the invention, the control unit 10, automatically accesses a web browser by selecting the URL character string contained in the received in the information and data. In still another embodiment of the invention, the control unit 10 deletes the received information and data that is processed according to the automatic processing system or stores received information and data in the specific box.

The display unit 30 displays messages generated while the programs are executed under the control of the control unit 10, and also displays key operation states of the user while a call function is executed.

The operation of the mobile telephone will now be explained with reference to FIG. 1. The user establishes a calling mode when a dialing operation is performed via the key pad 27. The control unit 10 detects the calling mode, processes the dialed information received via the data processing unit 23, converts the processed information into an RF signal via the RF unit 21, and outputs the RF signal. The control unit 10 detects via the RF unit 21 and the data processing unit 23 when a receiver of the called party generates a response signal. A call path is then formed via the audio processing unit 25. The call path allows the user to perform a call function.

When the mobile telephone is in a reception mode, the control unit 10 detects the condition via the data processing unit 23 and generates a ring signal via the audio processing unit 25. The control unit 10 detects the user's response, e.g., answering the mobile telephone. A call path is then established via the audio processing unit 25 to allow the user to perform the call function. It will be appreciated by those skilled in the art that although voice communication was given as an example for the calling and reception modes of the invention, a data communication function for packet data or image data can also be performed without departing from the scope of the invention. In a standby mode or character communication mode, the control unit 10 displays character data processed through the data processing unit 23 on the display unit 30.

The operation for sorting and processing the information and data received through the mobile telephone will now be explained. When the information and data are received through the mobile telephone, the control unit 10 confirms whether the received information and data contain a pattern stored in the memory 29. If the received information and data contain a pattern stored in memory 29, the control unit 10 sorts the pattern by its type. Thereafter, the control unit 10 provides the received information and data according to its pattern type to the sorting system, the processing system or the automatic processing system. If the received information and data are transmitted to the sorting system, the sorting system re-sorts the received information and data and stores them in a corresponding text box. If the received information and data are transmitted to the processing system, the processing system provides additional information or functionality to the received information and data and processes them, accordingly. If the received information and data are transmitted to the automatic processing system, the automatic processing system deletes the received information and data or stores them in the specific box without any user intervention.

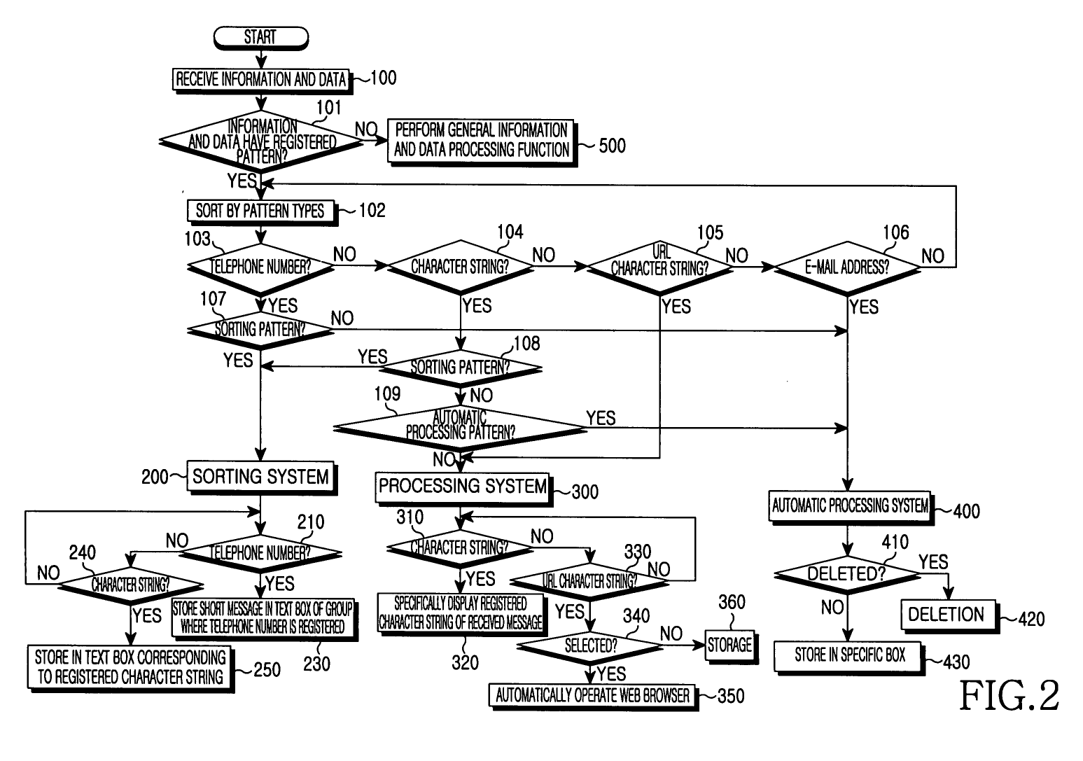

FIG. 2 is a flowchart showing an example of steps performed for processing the received information and data in the mobile telephone in accordance with an embodiment of the present invention.

FIG. 2 will be explained with reference to FIG. 1.

The control unit 10 detects the reception of the received information and data at the mobile telephone in step 100. The control unit 10 then detects whether the received information and data contain a pattern stored in the memory 29 in step 101. If not, the processing proceeds to step 500 where general information and data processing functions are performed.

However, if it is determined that the information and data have a registered pattern in step 101, the processing proceeds to step 102. In step 102, the pattern in the received information and data is sorted by types. For example, the control unit 10 detects whether the pattern in an email or short message is a telephone number stored in the phonebook of the mobile telephone associated with unwanted calls or messages from a business or individual. In step 103, the control unit 10 detects that the pattern in the received information and data is a phone number. If so, the processing proceeds to step 107, and if not, the processing proceeds to step 104 as discussed in more detail below. If the processing proceeds to step 107, a determination is made at step 107 as to whether the telephone number is sortable. If not, the processing proceeds to step 400 which is discussed in more detail below. However, if so, the processing proceeds to step 200. In step 200, the control unit 10 confirms whether the pattern of the received information and data is a registered telephone number or specific character string. If the received information and data are a short message or e-mail that includes a registered telephone number the control unit 10 detects it in step 210 and proceeds to step 230 where the information and data detected in step 210 is stored in the text box of the group in which the telephone number is stored. For example, if the received information and data are a short message or e-mail that includes a telephone number stored in the group of ‘Friends’, the short message or e-mail is stored in the text box classified as ‘Friends’.

However, when the information and data sorted in step 102 are a short message or e-mail containing a specific character string registered by the mobile telephone user to sort the information and data by themes, characteristics, categories or kinds, the control unit 10 determines this in step 103 as discussed above, and proceeds to step 104 where it detects the specific character string. If the controller then determines character string is of a sorting pattern in step 108, the processing proceeds to step 200. If the sorting system of step 200 has a telephone number and a specific character string as the pattern, the control unit 10 re-confirms whether the pattern of the received information and data is a telephone number or specific character string. If it is determined in step 200 that the received information and data does not include a telephone number, the control unit 10 detects in step 240 whether the received information and data are a short message and e-mail that includes a specific character string that was registered earlier in order to sort the information and data by themes, characteristics, categories or kinds. The control unit 10 proceeds to step 250 and stores the information and data detected in step 240 in a text box corresponding to the registered character string. For example, if the received information and data are short messages or e-mails that include the character string ‘Club’, the short message or e-mail is stored in the text box classified as ‘Club’.

The information and data including the telephone number or specific character string stored in steps 230 and 240 are stored by themes, categories, characteristics or kinds. In addition, sorting codes are generated, and indexes are added to the information and data, and stored and managed by sorting codes.

Returning to the discussion concerning the sorting performed in step 102, if the information and data sorted in step 102 contain a short message or e-mail that includes a character string registered by the mobile telephone user for specific display, the control unit 10 detects it in step 104 and proceeds to step 108. If it is determined in step 108 that there is no sorting pattern, the processing proceeds to step 109 where it is determined whether an automatic processing is to be performed. If not, the processing proceeds to step 400 as discussed in more detail below. However, if so, the processing proceeds to the processing system of step 300. In step 310, the control unit 10 re-confirms whether the pattern of the received information and data is a specific character string or a URL character string that was registered for specific display. If the control unit 10 detects in step 310 that the received information and data are a short message or e-mail that includes a character string registered for specific display. the processing performed by control unit 10 proceeds to step 320 where character string and the short message or e-mail are specifically displayed on the display unit 30. Thus, for example, the character string ‘Love’ is displayed in pink in a bold font if the mobile telephone user designates that the character string ‘Love’ is to be displayed in pink in a bold font.

As discussed above with regard to step 104, if the information and data sorted in step 102 is not a character string, in step 105, the control unit 10 detects when the information and data sorted in step 102 are a short message or e-mail that include a URL character string, namely a character string starting with ‘http://www’. If so, the processing proceeds to step 300. In the processing system of step 300 having a character string registered for specific display and a URL character string as the pattern, the control unit 10 re-confirms in step 310 that the character string is not a specific character string. In step 330 a determination is made as to whether the character string is a URL character string. When the user selects the URL character string included in the information and data, namely the character string starting with ‘http://www’, the control unit 10 selects in the URL in step 340. In step 350, the web browser is automatically operated to access a site selected by the mobile telephone user in step 340. For example, if the received information and data are a short message or e-mail that contain the URL character string, ‘http://www.daum.net’, and the mobile telephone user selects ‘http://www.daum.net’, the web browser is automatically operated to access the site. If the URL was not selected by the user in step 340, the received information and data containing the URL is stored in step 360.

Returning to the discussion of step 105, if the processing determines that the information is not a URL character string, the processing proceeds to step 106. If the control unit 10 determines in step 106 that the received information and data contains an email address, or the control unit 10 determines in step 107 that a sorting pattern for the phone number is not required, or the control unit 10 determines in step 109 that automatic processing for the character string is required, automatic processing is performed in step 400 by the control unit 10. A determination is made in step 410 whether to delete the short message or e-mail including the telephone number, specific character string and e-mail address. If so, the short message or e-mail including the telephone number, specific character string and e-mail address is not received by the mobile telephone but instead is deleted in step 420. If not, the short message or e-mail including the telephone number, specific character string and e-mail address is stored in a specific box in step 430. For example, if the received information and data are a short message or e-mail that include the telephone number or e-mail address implying commercial advertisements, or the character string ‘Advertisement’, the short message or e-mail is deleted or stored in the specific box before being received by the mobile telephone.

In an embodiment of the invention, the automatic processing system registers a virus code as a pattern. If the received information and data have the virus code as a pattern, the information and data can be deleted before being received by the mobile telephone.

As discussed earlier, in accordance an embodiment of the present invention, the information transmitted/received through the mobile telephone is examined by using patterns and processed upon the user's request. As a result, the information can be easily sorted, processed or automatically processed. While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for processing information and data in a mobile telephone, comprising the steps of:
confirming whether received information and data have a registered pattern;
sorting the received information and data containing the registered pattern by pattern types;
processing the information and data according to a sorting system when the pattern of the received information and data is at least one of a telephone number stored in a phonebook, and a specific character string registered to sort the information and data by at least one of themes, categories, characteristics and kinds; and
storing the received information and data containing the pattern in a text box.

2. The method as claimed in claim 1, further comprising storing said received information and data containing said telephone number as a pattern in said text box of a group in which said telephone number is stored according to the sorting system used.

3. The method as claimed in claim 2, further comprising storing said received information and data containing said specific character string as a pattern in said text box corresponding to the specific character string according to the sorting system used.

4. The method as claimed in claim 1,, wherein the telephone number stored in the phonebook and the specific character string registered to sort the information and data by categories, characteristics, themes and kinds are registered as patterns in the sorting system.

5. The method as claimed in claim 1, wherein the received information and data are individually stored by categories, characteristics, themes and kinds in the sorting system.

6. The method as claimed in claim 1, further comprising: adding indexes to the information and data using the sorting system.

7. The method as claimed in claim 6, further comprising:
storing the indexes by sorting codes.

8. The method as claimed in claim 15, wherein said registered pattern comprises a virus.

9. The method as claimed in claim 15, wherein said registered pattern comprises information that a user does not want to receive.

10. A method for processing information and data in a mobile telephone, comprising the steps of:
confirming whether received information and data have a registered pattern;
sorting the received information and data containing the registered pattern by pattern types;
processing the information and data according to a processing system when the pattern of the received information and data is includes at least one of a specific character string registered for specific display and a URL character string; and
displaying the received information and data containing the character string pattern registered for specific display on a display unit so that the character string can be specifically displayed.

11. The method of claim 10, further comprising:
accessing automatically a web browser of a URL when the URL character string is selected.

12. The method as claimed in claim 10, wherein the character string registered for specific display and the URL character string are registered as patterns of the processing system.

13. The method as claimed in claim 10, wherein the character string is specifically displayed in a designated color in a bold font.

14. The method as claimed in claim 12, wherein the URL character string comprises an ‘http://www’.

15. A method for processing information and data in a mobile telephone, comprising the steps of:
confirming whether received information and data have a registered pattern;
sorting the received information and data containing the registered pattern by pattern types;
processing the received information and data according to an automatic processing system when the pattern of the received information and data is at least one of a specific character string, telephone number and e-mail address registered by the user for rejection of reception at said mobile telephone; and
deleting the received information and data.

16. The method as claimed in claim 15 further comprising:
storing the received information and data containing said at least one of a specific character string, telephone number and e-mail address in a specific box.

17. The method as claimed in claim 16, wherein the at least one specific character string, telephone number and e-mail address are patterns of the automatic processing system.

18. The method as claimed in claim 16, wherein the at least one specific character string, telephone number and e-mail address is at least one of an advertisement short message, telephone number and junk e-mail.

19. A method for processing information and data in a mobile telephone, comprising the steps of:
confirming whether received information and data have a registered pattern;
sorting the received information and data containing the registered pattern by pattern types; and
processing the received information and data according to a sorting system when the pattern of the received information and data is at least one of a telephone number stored in a phonebook of said mobile telephone terminal and a specific character string registered to sort the received information and data by at least one of characteristics, categories, themes and kinds.

20. The method as claimed in claim 19, further comprising:
processing the information and data according to a processing system when the pattern of the received information and data is at least one of said character string registered for specific display and said URL character string.

21. The method as claimed in claim 19, further comprising:
processing the received information and data according to an automatic processing system when the pattern of the received information and data is said at least one of a specific character string, telephone number and e-mail address registered by the user for rejection of reception.

22. The method as claimed in claim 19, wherein the sorting system stores the information and data having the telephone number stored in the phonebook as the pattern in a text box of a group in which the telephone number is stored.

23. The method as claimed in claim 19, wherein the sorting system stores the information and data having the specific character string registered to sort the information and data by said characteristics, categories, themes and kinds as the pattern in a text box corresponding to the specific character string.

24. The method as claimed in claim 20, wherein the processing system displays the information and data having the character string registered for specific display as the pattern on the display unit so that the character string can be specifically displayed.

25. The method as claimed in claim 20, wherein the processing system automatically accesses a web browser of the URL when the URL character string is selected from the received information and data including the URL character string.

26. The method as claimed in claim 21, wherein the automatic processing system performs at least one of the operation of deleting the information and data and storing the information and data in a specific text box.

27. A computer readable medium of instructions for processing information and data in a mobile telephone, said computer readable medium of instructions comprising:
a first set of instructions, adapted to control the mobile telephone to confirm whether received information and data have a registered pattern;
a second set of instructions, adapted to control the mobile telephone to sort the received information and data containing the registered pattern by pattern types;
a third set of instructions, adapted to control the mobile telephone to process the information and data according to a sorting system when the pattern of the received information and data is at least one of a telephone number stored in a phonebook, and a specific character string registered to sort the information and data by at least one of themes, categories, characteristics and kinds; and
a fourth set of instructions, adapted to control the mobile telephone to store the received information and data containing the pattern in a text box.

28. The computer readable medium of instructions as claimed in claim 27, wherein the fourth set of instructions is adapted to control the mobile telephone to store the received information and data containing said telephone number as a pattern in said text box of a group in which said telephone number is stored according to the sorting system used.

29. The computer readable medium of instructions as claimed in claim 27, wherein the fourth set of instructions is adapted to control the mobile telephone to sort the received information and data containing said specific character string as a pattern in said text box corresponding to the specific character string according to the sorting system used.

30. The computer readable medium of instructions as claimed in claim 27, wherein the third set of instructions is adapted to control the mobile telephone to register the telephone number stored in the phonebook and the registered specific character string as patterns in the sorting system.

31. The computer readable medium of instructions as claimed in claim 27, wherein the third set of instructions is adapted to control the mobile telephone to individually store the received information and data by said categories, characteristics, themes and kinds in the sorting system.

32. The computer readable medium of instructions as claimed in claim 27, wherein the fourth set of instructions is adapted to control the mobile telephone to add indexes to the received information and data using the sorting system.

33. The computer readable medium of instructions as claimed in claim 32, wherein the fourth set of instructions is adapted to control the mobile telephone to store the indexes by sorting codes.

34. The computer readable medium of instructions as claimed in claim 41, wherein the third set of instructions is adapted to control the mobile telephone to include a virus as said registered pattern.

35. The computer readable medium of instructions as claimed in claim 41, wherein the third set of instructions is adapted to control the mobile telephone to classify said registered pattern as information that a user does not want to receive.

36. A computer readable medium of instructions for processing information and data in a mobile telephone, said computer readable medium of instructions comprising:
a first set of instructions, adapted to control the mobile telephone to confirm whether received information and data have a registered pattern;
a second set of instructions, adapted to control the mobile telephone to sort the received information and data containing the registered pattern by pattern types;
a third set of instructions, adapted to control the mobile telephone to process the information and data according to a processing system when the pattern of the received information and data contains at least one of a specific character string registered for specific display and a URL character string; and
a fourth set of instructions, adapted to control the mobile telephone to display the received information and data containing the character string pattern registered for specific display on a display unit so that the character string can be specifically displayed.

37. The computer readable medium of instructions as claimed in claim 36, wherein the fourth set of instructions is adapted to control the mobile telephone to access automatically a web browser of a URL when the URL character string is selected.

38. The computer readable medium of instructions as claimed in claim 36, wherein the fourth set of instructions is adapted to control the mobile telephone to register the character string registered for specific display and the URL character string as patterns of the processing system.

39. The computer readable medium of instructions as claimed in claim 36, wherein the fourth set of instructions is adapted to control the mobile telephone to specifically display the character string as a designated color in a bold font.

40. The computer readable medium of instructions as claimed in claim 36, wherein the fourth set of instructions is adapted to control the mobile telephone to detect the URL character string as an ‘http://www’.

41. A computer readable medium of instructions for processing information and data in a mobile telephone, said computer readable medium of instructions comprising:
a first set of instructions, adapted to control the mobile telephone to confirm whether received information and data have a registered pattern;
a second set of instructions, adapted to control the mobile telephone to sort the received information and data containing the registered pattern by pattern types;
a third set of instructions, adapted to control the mobile telephone to process the information and data according to an automatic processing system when the pattern of the received information and data is at least one of a specific character string, telephone number and e-mail address registered by the user for rejection of reception at said mobile telephone; and
a fourth set of instructions, adapted to control the mobile telephone to delete the received information and data.

42. The computer readable medium of instructions as claimed in claim 41, wherein the fourth set of instructions is adapted to control the mobile telephone to store the received information and data containing said at least one of a specific character string, telephone number and e-mail address in a specific box.

43. The computer readable medium of instructions as claimed in claim 41, wherein the fourth set of instructions is adapted to control the mobile telephone to define the at least one specific character string, telephone number and e-mail address as patterns of the automatic processing system.

44. The computer readable medium of instructions as claimed in claim 41, wherein the fourth set of instructions is adapted to control the mobile telephone to define the at least one specific character string, telephone number and e-mail address as at least one of an advertisement short message, telephone number and junk e-mail.

45. A computer readable medium of instructions for processing information and data in a mobile telephone, comprising the steps of:
a first set of instructions, adapted to control the mobile telephone to confirm whether received information and data have a registered pattern;
a second set of instructions, adapted to control the mobile telephone to sort the received information and data containing the registered pattern by pattern types; and
a third set of instructions, adapted to control the mobile telephone to process the received information and data according to a sorting system when the pattern of the received information and data is at least one of a telephone number stored in a phonebook of said mobile telephone terminal and a specific character string registered to sort the received information and data by at least one of characteristics, categories, themes and kinds.

46. The computer readable medium of instructions as claimed in claim 45, wherein the third set of instructions is adapted to control the mobile telephone to process the information and data according to a processing system when the pattern of the received information and data is at least one of said character string registered for specific display and said URL character string.

47. The computer readable medium of instructions as claimed in claim 45, wherein the third set of instructions is adapted to control the mobile telephone to process the received information and data according to an automatic processing system when the pattern of the received information and data is said at least one of a specific character string, telephone number and e-mail address registered by the user for rejection of reception.

48. The computer readable medium of instructions as claimed in claim 45, wherein the third set of instructions is adapted to control the mobile telephone to store the received information and data having the telephone number stored in the phonebook as the pattern in a text box of a group in which the telephone number is stored.

49. The computer readable medium of instructions as claimed in claim 45, wherein the third set of instructions is adapted to control the mobile telephone to store the information and data having the specific character string registered to sort the information and data by said characteristics, categories, themes and kinds as the pattern in a text box corresponding to the specific character string.

50. The computer readable medium of instructions as claimed in claim 46, wherein the third set of instructions is adapted to control the mobile telephone to display the received information and data having the character string registered for specific display as the pattern on the display unit.

51. The computer readable medium of instructions as claimed in claim 46, wherein the third set of instructions is adapted to control the mobile telephone to automatically access a web browser of the URL when the URL character string is selected from the received information and data including the URL character string.

52. The computer readable medium of instructions as claimed in claim 47, wherein the third set of instructions is adapted to control the mobile telephone to perform at least one of the operation of deleting the received information and data and storing the received information and data in a specific text box.
